(19) United States
(12) Patent Application Publication
(10) Pub. No.: US 2020/0296735 A1
(43) Pub. Date: Sep. 17, 2020

(54) RETRANSMISSION OF MESSAGES USING A NON-ORTHOGONAL MULTIPLE ACCESS (NOMA) COMMUNICATION SYSTEM

(71) Applicant: Telefonaktiebolaget LM Ericsson (publ), Stockholm (SE)

(72) Inventors: Behrooz MAKKI, Goteborg (SE); Ali Behravan, Stockholm (SE)

(73) Assignee: Telefonaktiebolaget LM Ericsson (publ), Stockholm (SE)

(21) Appl. No.: 16/084,103

(22) PCT Filed: May 14, 2018
(86) PCT No.: PCT/EP2018/062393

§ 371 Date: Sep. 11, 2018

(51) Int. Cl. H04W 72/12; H04L 1/18

(52) U.S. Cl. CPC H04W 72/12; H04L 1/1835; H04L 1/1812

(57) ABSTRACT

A “smart” hybrid automatic repeat request (HARQ) based method. In a downlink embodiment of the smart HARQ based method, a network node, using a set of one or more radio resources, transmits a first superimposed signal containing a message for a first UE and a second message for a second UE. If the network node receives a NACK from the first UE indicating that it could not decode either the first message or the second message and also receives a NACK from the second UE indicating that it could not decode the second message, the network node initially only retransmits one of the messages.

### TECHNICAL FIELD

Disclosed are embodiments related to non-orthogonal multiple access (NOMA) communication systems.

### BACKGROUND

The design of multiple access schemes is of interest in the design of cellular telecommunication systems. The goal of multiple access schemes is to provide multiple user equipments (UEs) (i.e., wireless communication devices, such as, for example, smartphones, tablets, phablets, smart sensors, wireless Internet-of-Things (IoT) devices, etc., that are capable of wirelessly communicating with an access point) with radio resources in a spectrum, cost, and complexity-efficient manner. In 1G-3G wireless communication systems, frequency division multiple access (FDMA), time division multiple access (TDMA) and frequency division multiple access (CDMA) schemes have been introduced. Long-Term Evolution (LTE) and LTE-Advanced employ orthogonal frequency division multiple access (OFDMA) and single-carrier (SC)-FDMA as orthogonal multiple access (OMA) schemes. Such orthogonal designs have the benefit that there is no mutual interference among UEs, leading to high system performance with simple receivers.

Recently, non-orthogonal multiple access (NOMA) has received considerable attention as a promising multiple access technique for LTE and 5G systems. With NOMA, two or more UEs may share the same time resource and frequency resource as well as, if applicable, the same code resource and beam resource. Particularly, 3GPP has considered NOMA in different applications. For instance, NOMA has been introduced as an extension of the network-assisted interference cancellation and suppression (NAICS) for intercell interference (ICI) mitigation in LTE Release 12 as well as a study item of LTE Release 13, under the name of “Downlink multiuser superposition transmission.” Also, in recent 3GPP meetings, it is decided that new radio (NR) should target to support (at least) uplink NOMA, in addition to the OMA approach.

### SUMMARY

NOMA exploits channel difference between or among UEs to improve spectrum efficiency. Generally, the highest gain of NOMA is observed in the cases where a “strong” UE (i.e., a UE experiencing a good channel condition with a base station, such as, for example, a UE located in the center of a cell) and a “weak” UE (i.e., a UE having a poor channel condition with the base station, such as, for example, a UE located at or near a cell edge) are grouped (i.e., use the same radio resources). However, the implementation of NOMA implies: 1) use of more advanced and complex receivers to enable multiuser signal separation, 2) more difficult synchronization, and 3) a higher signal decoding delay

For example, considering downlink NOMA, the strong UE typically uses successive interference cancellation (SIC) to first decode and remove the message for the weak UE and then decode its own message interference-free. As a result, compared to conventional OMA scheme, NOMA-based data transmission leads to higher receiver complexity. Also, compared to OMA-based systems, the two-step decoding process of the strong UE may lead to larger end-to-end transmission delay for the strong UE, as well as for the weak UE (e.g. in scenarios in which their signals should be synchronized). Also, there is a probability that the strong UE cannot correctly decode the message of the weak UE affecting the successful decoding probability of its own message.

Also, while using NOMA outperforms OMA in terms of sum rate, the sum rate gain of NOMA is at the cost possible rate loss for the weak UE (e.g., the cell-edge UE). This is because, with downlink NOMA, the weak UE considers the signal of the strong UE as interference and uses the typical OMA-based decoder to decode its own message. Thus, there is a significant probability that neither the strong UE nor the weak UE can decode the message intended for it, thus requiring the network to re-transmit the messages.

This disclosure describes, among other things, a method that improves downlink (DL) and uplink (UL) message throughput in a NOMA system. The method may be referred to as a “smart” hybrid automatic repeat request (HARM) based method. In a downlink embodiment of the smart HARQ based method, a network node, using a set of one or more radio resources, transmits a first superimposed signal containing a message for a first UE and a second message for a second UE. If the network node receives a NACK from the first UE indicating that it could not decode either the first message or the second message and also receives a NACK from the second UE indicating that it could not decode the second message, the network node initially only retransmits one of the messages. More specifically, for example, the network node transmits a second superimposed signal containing the second message for the second UE and a new (third) message for the first UE but not containing the first message for the first UE. In this scenario, it is possible that, as a result of receiving the second superimposed signal, the first UE is able to decode the second message and then use this decoded message to decode both the first message and the new message.

Hence, throughput is greatly improved because the network does not need to retransmit the first message even though the first UE was initially unable to obtain the first message from the first superimposed signal. While embodiments are exemplified using the simplest case of two UEs and downlink transmission, the embodiments can be adapted to the cases with arbitrary number of UEs and uplink transmission as well.

Accordingly, in one embodiment there is provided a method for transmitting messages to a first UE and a second UE. The method is performed by a network node (NN) and includes the NN transmitting first superimposed signal comprising a first message for the first UE and a second message for the second UE. The method also includes the NN determining that the first UE was not able to successfully decode either the first message or the second message. The method also includes the NN determining that the second UE was not able to successfully decode the second message. The method also includes the NN, in response to determining that the first UE was not able to successfully decode either the first message or second message and that the second UE was not able to successfully decode the second message, deciding to retransmit the second message but not the first message. The method also includes the NN retransmitting the second message by transmitting a second superimposed signal comprising the second message for the second UE and a third message for the first UE but not including the first message, wherein the third message is different than the first message.

In another embodiment there is provided a method for receiving messages transmitted by a network node. The method is performed by a first UE and includes the first UE receiving a first superimposed signal transmitted by the network node, the first superimposed signal comprising a first message for the first UE and a second message for a second UE. The method also includes the first UE attempting to decode the second message for the second UE prior to attempting to decode the first message for the first UE. The method also includes, after attempting to decode the second message, the first UE providing an indication to the network node indicating that the second message has not been successfully decoded. The method also includes the first UE buffering the first superimposed signal. The method also includes, after providing the indication to the network node, the first UE receiving a second superimposed signal transmitted by the network node, the second superimposed signal comprising the second message for the second UE and a third message for the first UE but not including the first message for the first UE, wherein the third message is different than the first message. The method also includes, after receiving the second superimposed signal, the first UE successfully decoding the second message for the second UE. The method also includes, after successfully decoding the second message for the second UE, the first UE using the decoded second message and the buffered first superimposed signal to decode the first message from the first superimposed signal.

In another embodiment there is provided a method for obtaining a first message transmitted by a first UE and a second message transmitted by a second UE. The method is performed by a network node (NN) and includes the NN scheduling the first UE to transmit the first message using a first time and frequency resource and scheduling the second UE to transmit the second message using the first time and frequency resource. The method also includes the NN receiving a first signal comprising the first message and the second message, and, as a result of not being able to obtain either the first message or the second message from the signal, the NN performs performing steps comprising: buffering the first signal; scheduling the first UE to retransmit the first message using a second time and frequency resource; and scheduling the second UE to transmit a third message using the second time and frequency resource, wherein the third message is different than the second message.

In another embodiment there is provided a method for transmitting messages to a network node. The method is performed by a UE and includes the UE receiving a first scheduling message transmitted by the network node. The method also includes, as a result of receiving the first scheduling message, the UE transmitting a first signal comprising a first message. The method also includes the UE, after transmitting the first signal, buffering the first message in case the network node requires the UE to retransmit the first message. The method also includes the UE, after buffing the first message, receiving a second scheduling message transmitted by the network node, the second scheduling message instructing the UE to transmit a second message. The method also includes the UE, as a result of receiving the second scheduling message, transmitting a second signal comprising the second message but not comprising the first message. The method also includes the UE, after transmitting the second signal, receiving: i) acknowledgment information transmitted by the network node, wherein the acknowledgment information indicates that the network node has been able to obtain the first message from the first signal and the second message from the second signal, or ii) a request to retransmit the first message.

### BRIEF DESCRIPTION OF THE DRAWINGS

The accompanying drawings, which are incorporated herein and form part of the specification, illustrate various embodiments.

FIG. 1 illustrates a network node communicating simultaneously with a first UE and a second UE.

FIG. 2 illustrates processing that occurs during a time slot.

FIG. 3 illustrates processing, according to one embodiment, that occurs during first and second time slots.

FIG. 4 is a flow chart illustrating a process according to one embodiment.

FIG. 5 is a flow chart illustrating a process according to one embodiment.

FIG. 6 is a flow chart illustrating a process according to one embodiment.

FIG. 7 is a flow chart illustrating a process according to one embodiment.

FIG. 8 is a block diagram of a network node according to one embodiment.

FIG. 9A is a diagram showing functional units of a network node according to an embodiment.

FIG. 9B is a diagram showing functional units of a network node according to an embodiment.

FIG. 10 is a block diagram of a UE according to one embodiment.

FIG. 11A is a diagram showing functional units of a UE according to one embodiment.

FIG. 11B is a diagram showing functional units of a UE according to one embodiment.

FIG. 12 schematically illustrates a telecommunication network connected via an intermediate network to a host computer.

FIG. 13 is a generalized block diagram of a host computer communicating via a base station with a user equipment over a partially wireless connection.

FIG. 14 is a flowchart illustrating a method implemented in a communication system including a host computer, a base station and a user equipment.

FIG. 15 is a flowchart illustrating a method implemented in a communication system including a host computer, a base station and a user equipment.

FIG. 16 is a flowchart illustrating a method implemented in a communication system including a host computer, a base station and a user equipment.

FIG. 17 is a flowchart illustrating a method implemented in a communication system including a host computer, a base station and a user equipment

### DETAILED DESCRIPTION

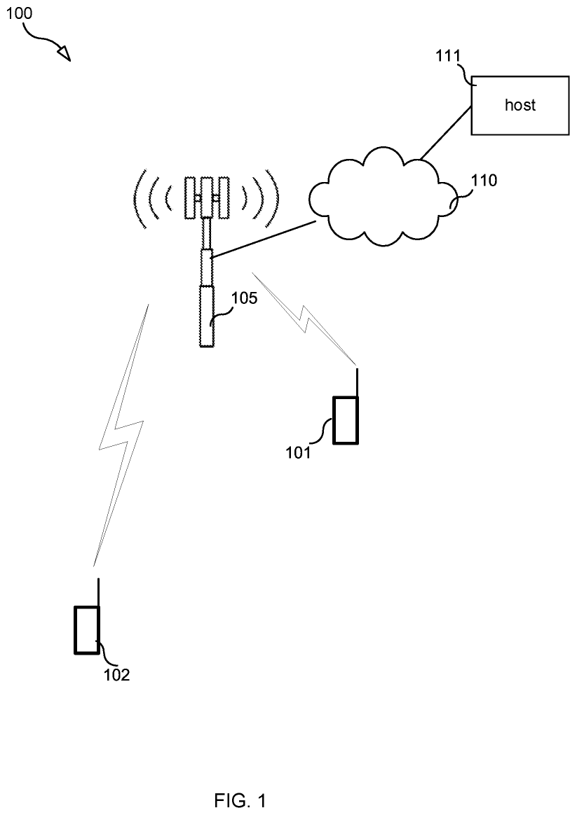

FIG. 1 illustrates a network 100 having a network node (NN) 105 (e.g., a system comprising a 4G or 5G base station or other access point) serving two UEs: UE 101 and UE 102. The two UEs have different channel (or “link”) qualities. In this scenario, UE 102 is a “weak” UE (e.g., a cell-edge UE) and UE 101 is a “strong” UE (e.g. a cell-center UE).

With respect to uplink OMA transmissions, the UE 101's and UE 102's signals are transmitted in orthogonal resources, for instance at the same time but in different frequency bands, and NN 105 decodes the two transmitted signals separately. With respect to downlink OMA transmissions, NN 105 transmits for UE 101 a first signal using for example a first frequency band and transmits for UE 102 a second signal using for example a second frequency band that does not overlap with the first frequency band.

With respect to uplink NOMA, on the other hand, the UEs share the same frequency (or “spectrum”), time resources, and code or spreading resources, if any, to send their messages simultaneously. That is, NN 105 receives a superimposed signal containing the message transmitted by UE 101 and the message transmitted by UE 102. In such a NOMA scenario, NN 105, using for example a SIC receiver, first decodes the message of UE 101 (the “strong” UE), considering the message of UE 102 as noise. Then, after successfully decoding UE 101's message, NN 105 subtracts UE 101's message from the received signal and decodes UE 102's signal with no interference from UE 101.

Likewise, with respect to downlink NOMA, UE 101 and UE 102 are served by NN 105 in common radio resources, i.e., time-frequency chunks, as well as common code and/or beam resources, if applicable. We shall consider a frequency slot so that the time-frequency chunks refer to different time slots. Then, with no loss of generality, suppose that UE 101 experiences a better channel quality compared to UE 102 (i.e., UE 101 is the strong UE and UE 102 is the weak UE). That is, we have |h₂|≤|h₁|, where h₁ represents the channel coefficient of the NN 105-UE 101 link and h₂ represents the channel coefficient of the NN-UE link. We define the channel gains as gᵢ=|hᵢ|², i=1, 2.

Using NOMA, in time slot t NN 105 generates and transmits a superimposed signal S(t)=\sqrt{P₁}M₁(t)+\sqrt{P₂}M₂(t) to both UEs in the same resources. Here, M₁(t) and M₂ (t) are the unit-variance messages for UE 101 and UE 102, respectively, and Pᵢ, i=1, 2, are their corresponding transmit powers with P₁+P₂=P where P is the NN total power. In this way, the signal received by UE 101 (i.e., Yᵢ(t)) and the signal received by UE 102 (i.e., Y₂(t)) is given by:

Yᵢ(t)=hᵢ(\sqrt{P₁}M₁(t)+\sqrt{P₂}M₂(t))+Zᵢ(t), i=1,2, (1)

where

Zᵢ(t) denotes a noise signal (e.g., Gaussian white noise).

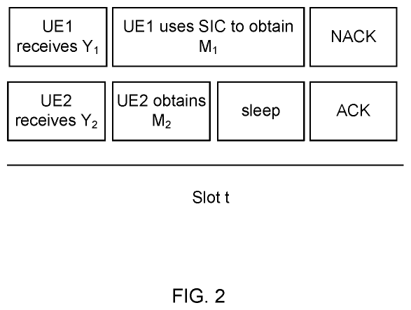

In the above scenario, which is illustrated in FIG. 2, UE 101 uses a SIC receiver to first decode-and-remove the message for UE 102 (i.e., M₂) and then obtain its own message (M₁) with no interference. The UE with the worse channel quality, i.e., UE 102 uses typical decoders to decode its own message in the presence of interference of the signal for UE 101.

The goal of each UE is to decode its own message, although they may decode the message of the other UE to reduce the interference. With conventional NOMA, UE 102 considers the signal for UE 101 as interference and uses OMA-based receivers to decode its own message. This is because it can be theoretically shown that there is no chance that UE 102 can first decode-and-remove the message of UE 101 (and then, decode its own message interference-free). UE 101, on the other hand, uses a SIC receiver to first decode-and-remove the message of UE 102 and then decode its own message interference-free.

Compared to conventional OMA-based receivers, SIC is a high-complexity scheme. Also, because the desired signal is decoded in two steps, SIC implies larger decoding delay which affects, e.g., the HARQ feedback process and, thereby, may increase the end-to-end transmission delay for both UEs in the situations where UE 102's signal should be synchronized with the signal of the UE 101 (different methods can be applied to synchronize the signals—for instance, some sleeping period may be considered by UE 102 (as illustrated in FIG. 2) or NN 105 may synchronize the signals of the UEs). Finally, with SIC, there is a probability of error propagation. This is because, if the message of UE 102 is not correctly decoded in the first step, the interference is not removed which reduces the probability that the cell-center can successfully decode its own message.

With this setup, the achievable rate for UE 101 (i.e., R₁) and the achievable rate for UE 102 (i.e., R₂) is given by:

$$\{ \begin{matrix}{R}_{1} = {log}_{2} ( 1 + {P}_{1} {g}_{1} ) , \\ {R}_{2} = {log}_{2} ( 1 + \frac{{P}_{2} {g}_{2}}{1 + {P}_{1} {g}_{2}} ) .\end{matrix} \qquad ( 2 )$$

Due to the interference signal of UE 101, UE 102 experiences a low channel quality and may need retransmissions to decode its messages.

Depending on the channels quality, there is a probability that UE 101 can not decode-and-remove the message for UE 102. In this case, the error propagates, and the additional interference increases the probability that UE 101 can not decode its own message correctly.

In this way, compared to OMA-based systems, there may be a higher probability that the UEs need retransmissions for successful message decoding. However, HARQ-based retransmissions reduce the network throughput, which is the main winning point of NOMA compared to OMA. Thus, to implement an efficient NOMA-based setup, it would be useful to reduce retransmissions.

Assume that UE 101 (denoted “UE1”) has been able to decode none of the messages that are intended for U1 and UE 102 (denoted “UE2”), and UE2 cannot decode its own message. However, similar approach is applicable if UE1 can decode the message of UE2 but none of the UEs can decode their own messages.

In a conventional system, with no successful message decoding at the UEs, both of their signals should be retransmitted by NN 105. Proposed herein is that NN 105 delays the message retransmission of UE1 while UE1 buffers the undecoded signal. That is, if none of the UEs have been able to decode the messages correctly, NN 105 retransmits the message for UE2 while sending a new messages for UE1. Then, buffering the undecoded message, in the next time slot UE1 utilizes the signal retransmitted for UE2 to decode and remove the interference. If it is successful to remove the interference, it retries to decode its own message. This is because the removed interference improves the quality of the received useful signal and, as a result, UE1 has a better chance to decode its own signal with no retransmissions. In other words, typical non-NOMA systems utilize the retransmissions to improve the power of the useful signal. With NOMA, however, one can use the retransmitted message of the other UE to reduce the interference power, which improves the received signal-to-interference-and noise ratio (SINR).

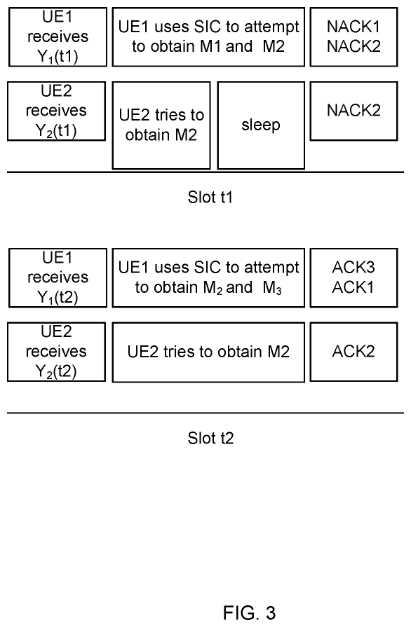

FIG. 3 illustrates an embodiment. In this embodiment, in time slot tl NN 105 transmits a first superimposed signal containing a message for UE1 (i.e., M1 and a message for UE2 (i.e., M2). Accordingly, in slot tl, UE1 receives Y1 (t1), which contains M1 and M2, and UE2 receives Y2 (t1), which also contains M1 and M2. Assume that in time slot tl, using a SIC-based decoder, UE1 cannot decode M1 or M2 and buffers the signal that it received (i.e., Y1 (t1)), and using a non-SIC-based decoder UE2 cannot decode M2 and buffers the signal that it received (i.e., Y2 (t1)). Hence, as shown in FIG. 3, UE1 informs NN 105 that it could not obtain either M1 or M2 (e.g., UE1 sends two NACKs to NN 105), and UE2 informs NN 105 that it could not obtain M2 (e.g. UE2 sends a NACK to NN 105).

Subsequently, in time slot t2, NN 105 retransmits M2 but sends a new message M3 for UE1. That is, in slot t2, NN 105 transmits a second superimposed signal containing M2 and M3, but not containing M1. Accordingly, in slot t2, UE1 receives Y1 (t2), which contains M3 and M2, and UE2 receives Y2 (t2), which also contains M3 and M2.

Then, using the SIC-based decoding approach, UE1 tries to decode and remove M2 using its two received copies of this signal. If UE1 decodes M2 correctly, it has the chance to decode M1 and M3 with no retransmission of M1. Assuming that UE1 is able to obtain M1 and M3 in time slot t2, UE1 informs NN 105 (e.g., as shown in FIG. 3, UE1 transmits two ACKs to NN 105, one for each message). Assuming that UE1 is still unable to obtain M1, NN 105 may retransmit M1 when a) retransmission of M2 stops (either because U2 has decoded M2 correctly or the maximum number of retransmission rounds is reached) or b) UE1 is able to decode M2 but is not able to decode M1. Accordingly, for this embodiment, in each time slot: 1) UE1 attempts to decode all different, buffered and recently received, signals, 2) UE1 sends acknowledgement/negative acknowledgement (ACK/NACK) feedbacks for all messages it tries to decode and 3) NN 105 informs the UEs if it is retransmitting a specific signal (or the UEs are informed by other means).

In summary, the following signaling procedure may be applied by NN 105 and UE1. In each time slot, UE1 tries to decode all recently received and undecoded-and-buffered signals. Then, it sends separate ACK/NACK signals to inform NN 105 about the message decoding status of each signal. Depending on the messages decoding status, NN 105 may delay the retransmission of the signals for UE1. Also, if it retransmits a signal, it informs the UEs about the index of the message which is retransmitted.

In the above example, UE1 cannot decode either M1 or M2 and UE2 cannot decode M2. A similar approach is applicable if UE1 can decode M2 but not M1 and UE2 cannot decode M2. In this scenario, NN 105 delays the retransmission of M2 while it retransmits Ml. Then, utilizing the two copies of the interference signal, UE2 has the chance to decode and remove the interference signal of UE1, which gives UE2 the chance to decode its own message (M2) interference-free and with no need for retransmissions.

As the above demonstrates, an advantage provided by the above embodiments is that they reduce the decoding complexity at the UEs and increase throughput because there is a chance that the UEs decode the undecoded messages with no need for retransmissions.

Also, the above described embodiments illustrate the DL NOMA transmission scenario, but the same approach is applicable for UL NOMA transmissions. With respect to UL NOMA transmission (i.e., wherein UE1 transmits a message (M1) using radio resources and UE2 transmits a message (M2) using the same radio resources and NN 105 uses a SIC-based decoding approach to obtain M1 and M2), if NN 105 fails to decode both messages, it first asks one of the UEs for a retransmission, while the other UE sends a new message (M3). For example, NN 105 instructs UE1 to retransmit M1 and instructs UE2 to transmit M3 using the same radio resources. Then, again using the SIC-based decoding approach, NN 105 tries to decode the retransmitted message M1, and if NN 105 is successful in obtaining M1, NN 105 will have a chance to of decoding M2 from the first received signal with no need for retransmission of M2.

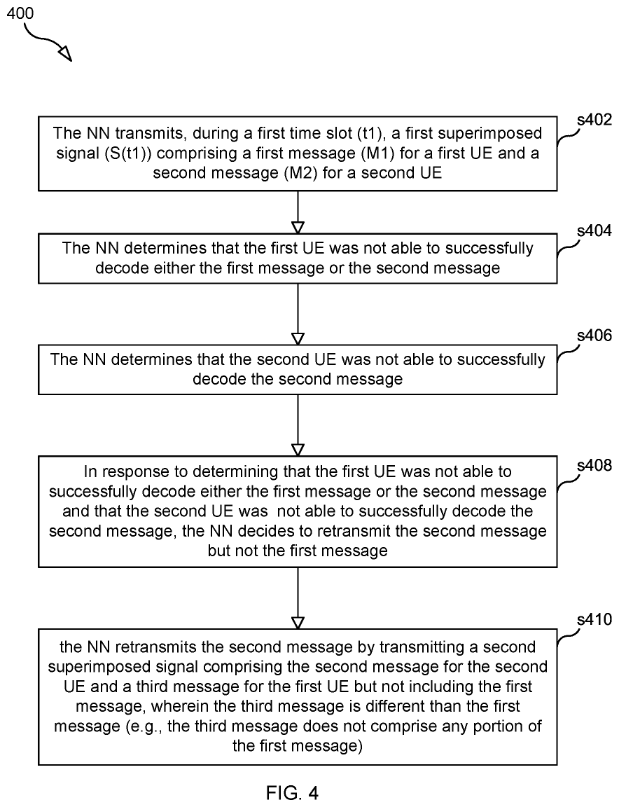

FIG. 4 is a flow chart illustrating a process 400, according to an embodiment, that is performed by NN 105. Process 400 may begin in step s402.

In step s402, NN 105 transmits, during a first time slot (t1), a first superimposed signal (S(t1)) comprising a first message (M1) for a first UE (e.g., UE 101 or UE 102) and a second message (M2) for a second UE (e.g., UE 101 or UE 102).

In step s404, NN 105 determines that the first UE was not able to successfully decode either the first message or the second message.

In step s406, NN 105 determines that the second UE was not able to successfully decode the second message;

In step s408, in response to determining that the first UE was not able to successfully decode either the first message or the second message and that the second UE was not able to successfully decode the second message, NN 105 decides to retransmit the second message but not the first message.

In step s410, NN 105 retransmits the second message by transmitting a second superimposed signal comprising the second message for the second UE and a third message for the first UE but not including the first message, wherein the third message is different than the first message (e.g., the third message does not comprise any portion of the first message).

In some embodiments, prior to transmitting the first superimposed signal comprising M1 and M2, NN 105 obtains (receives, generates or otherwise obtains) M1 and M2 and then generates the first superimposed signal (S1) (i.e., S1=M1+M2). For instance, NN 105 may receive M1 from a first host computer 111 (see FIG. 1) and may receive M2 from the first host computer or a second host computer (not shown).

In some embodiments, process 400 further includes, after transmitting the second superimposed signal and without any retransmission of the first message, NN 105 receives a positive acknowledgement (ACK) transmitted by the first UE, the ACK indicating that the first UE has successfully decoded the first message.

In some embodiments, process 400 further includes, after retransmitting the second message, determining that the first UE is still unable to decode the first message, but the second UE has successfully decoded the second message; and as a result of determining that the first UE is still unable to decode the first message, but the second UE has successfully decoded the second message, retransmitting the first message.

In some embodiments, process 400 further includes, after deciding to retransmit the second message but not the first message, informing the first UE that the second messing is being retransmitted.

In some embodiments, NN 105 determines that the first UE was not able to successfully decode either the first message or the second message by receiving a NACK corresponding to the first message and a second NACK corresponding to the second message, the first NACK indicating that the first UE was not able to successfully decode the first message, and the second NACK indicating that the first UE was not able to successfully decode the second message.

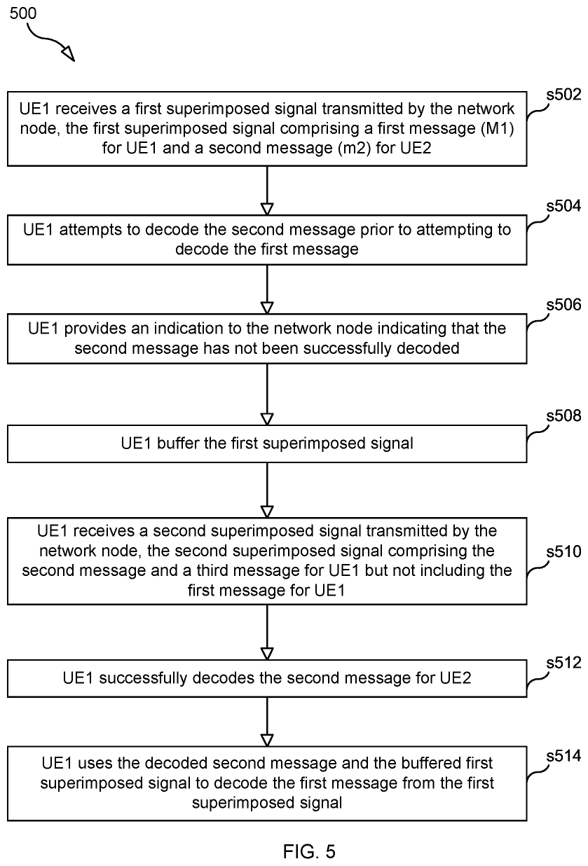

FIG. 5 is a flow chart illustrating a process 500, according to an embodiment, that is performed by UE1. Process 500 may begin in step s502.

In step s502, UE1 receives a first superimposed signal transmitted by the network node, the first superimposed signal comprising a first message (M1) for UE1 and a second message (m2) for UE2.

In step s504, UE1 attempts to decode the second message prior to attempting to decode the first message.

In step s506, UE1, after attempting to decode the second message, UE1 provides an indication to the network node indicating that the second message has not been successfully decoded.

In step s508, UE1 buffer the first superimposed signal.

In step s510, after providing the indication to the network node, UE1 receives a second superimposed signal transmitted by the network node, the second superimposed signal comprising the second message and a third message for UE1 but not including the first message for UE1, wherein the third message is different than the first message.

In step s512, after receiving the second superimposed signal, UE1 successfully decodes the second message for UE2.

In step s514, after successfully decoding the second message for UE2, UE1 uses the decoded second message and the buffered first superimposed signal to decode the first message from the first superimposed signal.

In some embodiments, process 500 further includes, after receiving the second superimposed signal and without receiving any retransmission of the first message, UE1 transmits a positive acknowledgement, ACK, the ACK indicating that UE1 has successfully decoded the first message.

In some embodiments, process 500 further includes, UE1 receiving information transmitted by the network node, the information indicating that the second messing is being retransmitted together with the third message.

In some embodiments, providing the indication to the network node comprises UE1 transmitting a negative acknowledgement, NACK, indicating that it was not able to successfully decode the second message.

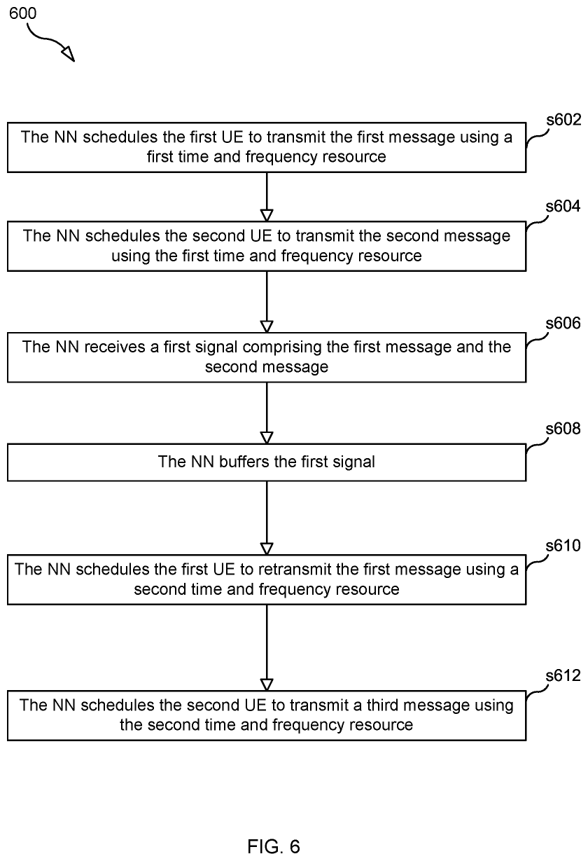

FIG. 6 is a flow chart illustrating a process 600, according to an embodiment, that is performed by NN 105 for obtaining a first message (M1) transmitted by a first UE (e.g., UE1) and a second message (M2) transmitted by a second UE (e.g, UE2). Process 600 may begin in step s602.

In step s602, NN 105 schedules the first UE to transmit the first message using a first time and frequency resource.

In step s604, NN 105 schedules the second UE to transmit the second message using the first time and frequency resource.

In step s606, NN 105 receives a first signal comprising the first message and the second message.

As a result of not being able to obtain either the first message or the second message from the first signal, NN 105 performs steps comprising: buffering the first signal (step s608); scheduling the first UE to retransmit the first message using a second time and frequency resource (step s610); and scheduling the second UE to transmit a third message using the second time and frequency resource (step s612), wherein the third message is different than the second mes sage.

In some embodiments, process 600 also includes NN 105 performing steps comprising: receiving a second signal comprising the first message and the third message; obtaining the first message from the second signal; obtaining the third message from the second signal; and using the first message obtained from the second signal and the buffered first signal, obtaining the second message from the first signal. In some embodiments, obtaining the second message from the first signal comprises: removing the first message from the first signal, thereby producing a residual signal comprising the second message; and obtaining the second message from the residual signal.

In some embodiments, process 600 also includes NN 105 receiving a second signal comprising the first message and the third message; and, as a result of not being able to obtain either the first message or the third message from the second signal, performing steps comprising: buffering the second signal; scheduling the first UE to retransmit the first message using a third time and frequency resource; and scheduling the second UE to transmit a fourth message using the second time and frequency resource, wherein the fourth message is different than the second and third message.

In some embodiments, scheduling the second UE to transmit a third message comprises transmitting to the second UE a scheduling message (e.g., a Downlink Control Information (DCI) message) comprising information for causing the second UE to buffer the second message in case the second UE needs to retransmit the second message.

In some embodiments, after successfully obtaining the first message (M1) and the second message (M2), NN 105 may forward M1 towards a first host computer 111 and may forward M2 towards a second host computer (or the first host computer 111).

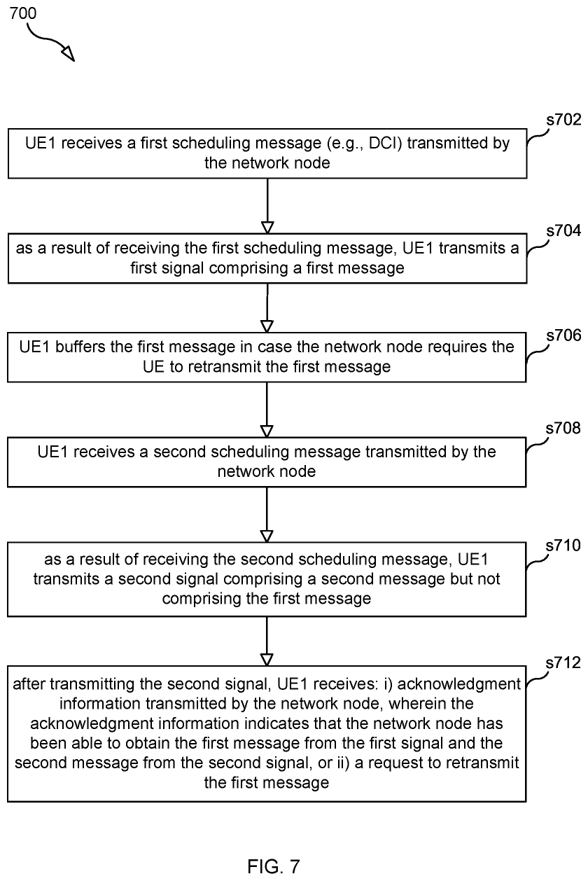

FIG. 7 is a flow chart illustrating a process 700, according to an embodiment, that is performed by UE1 for transmitting messages to a network node. Process 700 may begin in step s702.

In step s702, UE1 receives a first scheduling message (e.g., DCI) transmitted by the network node.

In step s704, as a result of receiving the first scheduling message, UE1 transmits a first signal comprising a first message.

In step s706, after transmitting the first signal, UE1 buffers the first message in case the network node requires the UE to retransmit the first message (e.g., stores the first message in a retransmit queue).

In step s708, after buffing the first message, UE1 receives a second scheduling message transmitted by the network node, the second scheduling message instructing the UE to transmit a second message.

In step s710, as a result of receiving the second scheduling message, UE1 transmits a second signal comprising the second message but not comprising the first message.

In step s712, after transmitting the second signal, UE1 receives: i) acknowledgment information transmitted by the network node, wherein the acknowledgment information indicates that the network node has been able to obtain the first message from the first signal and the second message from the second signal, or ii) a request to retransmit the first message.

In response to receiving the acknowledgment information indicating that the network node has been able to obtain the first message from the first signal and the second message from the second signal, UE1 de-buffers the first message (e.g., removes the first message from the retransmit queue).

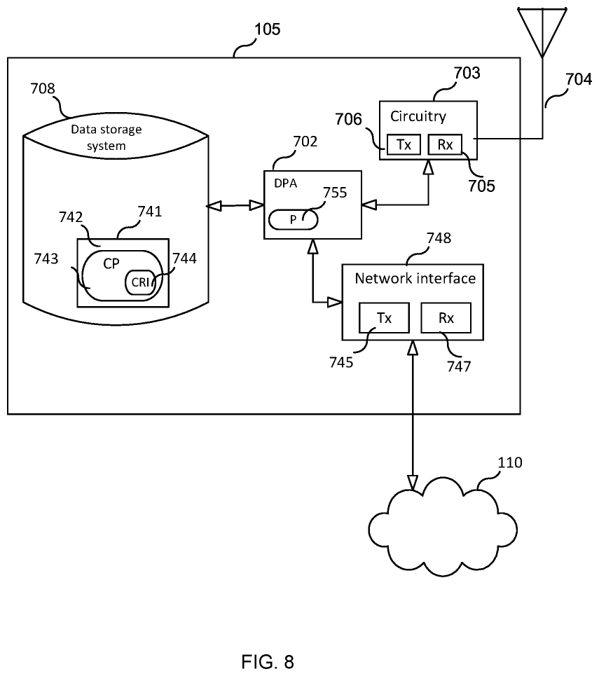

FIG. 8 is a block diagram of network node 150, according to some embodiments for performing methods disclosed herein. As shown in FIG. 8, network node 150 may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located or distributed in different locations; a network interface 848 comprising a transmitter (Tx) 845 and a receiver (Rx) 847 for enabling network node 150 to transmit data to and receive data from other nodes connected to a network 110 (e.g., an Internet Protocol (IP) network) to which network interface 848 is connected; circuitry 803 (e.g., radio transceiver circuitry comprising an Rx 805 and a Tx 806) coupled to an antenna system 804 for wireless communication with UEs); and a local storage unit (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes network node 150 to perform steps described herein (e.g., steps described herein with reference to the flow charts). In other embodiments, network node 150 may be configured to perform steps described herein without the need for code. That is, for example, PC 802 may consist merely of one or more ASICs. Hence, the features of the embodiments described herein may be implemented in hardware and/or software.

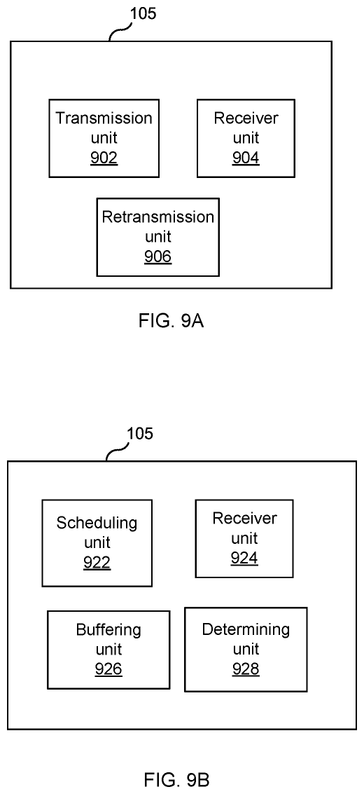

FIG. 9A is a diagram showing functional units of network node 105 according to an embodiment. In the embodiment shown, network node 105 includes: a transmission unit 902 for employing a transmitter to transmit a first superimposed signal comprising a first message for UE1 and a second message for UE2; and a receiver unit 904 for employing a receiver to i) obtain a message transmitted by UE1 indicating that UE1 was unable to decode the first message for UE1 and the second message for UE2 and ii) obtain a message transmitted by UE2 indicating that UE2 was unable to decode the second message; and a retransmitting unit 906 for delaying the retransmission of the first message, but not delaying the retransmission of the second message by transmitting a second superimposed signal comprising a third message for UE1 and the second message for UE2.

FIG. 9B is a diagram showing functional units of network node 105 according to an embodiment. In the embodiment shown, network node 105 includes: a scheduling unit 922 for scheduling a first UE to transmit a first message using a first time and frequency resource and scheduling a second UE to transmit a second message using the first time and frequency resource; a receiver unit 924 configured to receive via a receiver a first signal comprising the first message and the second message; a buffering unit 926; and a determining unit 930. The determining unit 930 is operable to determine whether the NN 105 is able to obtain either the first message or the second message from the first signal. As a result of the determining unit 930 determining that NN 105 is not able to obtain either the first message or the second message from the first signal, the buffering unit 926 buffers the first signal and the scheduling unit 922 schedules the first UE to retransmit the first message using a second time and frequency resource and schedules the second UE to transmit a third message using the second time and frequency resource, wherein the third message is different than the second message.

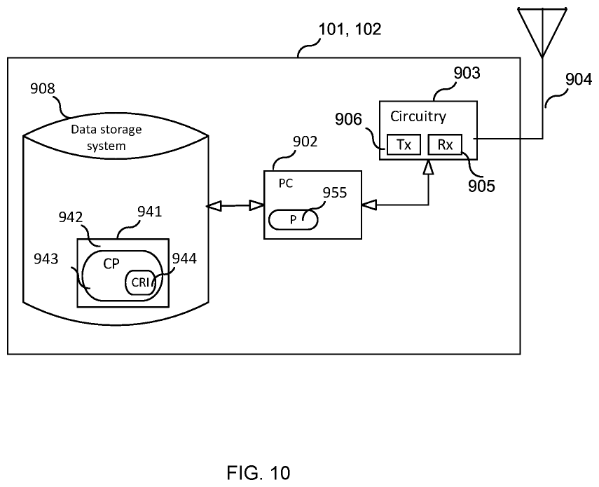

FIG. 10 is a block diagram of a UE (e.g. UE 101 or UE 102), according to some embodiments. As shown in FIG. 10, the UE may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like); circuitry 1003 (e.g., radio transceiver circuitry comprising an Rx 1005 and a Tx 1006) coupled to an antenna system 1004 for wireless communication); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes the UE to perform steps described herein (e.g., steps described herein with reference to the flow charts). In other embodiments, the UE may be configured to perform steps described herein without the need for code. That is, for example, PC 1002 may consist merely of one or more ASICs. Hence, the features of the embodiments described herein may be implemented in hardware and/or software.

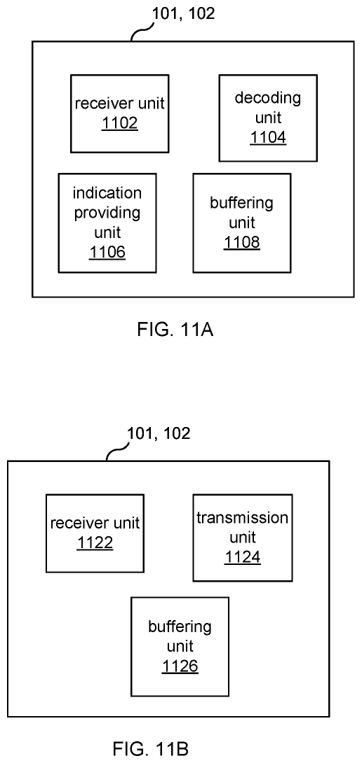

FIG. 11A is a diagram showing functional units of a UE (e.g., UE 101 or UE 102) according to an embodiment. In the embodiment shown, the UE includes: a receiver unit 1102 for employing a receiver to receive a first superimposed signal transmitted by the network node, the first superimposed signal comprising a first message for the first UE and a second message for the second UE; a decoding unit 1104 for attempting to decode the second message from the first superimposed signal prior to attempting to decode the first message for the first UE; an indication providing unit 1106 for providing an indication to the network node indicating that the second message has not been successfully decoded; and a buffering unit 1108 for buffering the first superimposed signal. The receiver unit 1102 is further operable to employ the receiver to receive a second superimposed signal transmitted by the network node, the second superimposed signal comprising the second message for the second UE and a third message for the first UE but not including the first message for the first UE, wherein the third message is different than the first message. The decoding unit 1104 is further operable to decode the second message for the second UE and, after successfully decoding the second message for the second UE, use the decoded second message and the buffered first superimposed signal to decode the first message from the first superimposed signal.

FIG. 11B is a diagram showing functional units of a UE (e.g., UE 101 or UE 102) according to an embodiment. In the embodiment shown, the UE includes: a receiver unit 1122 for receiving a first scheduling message transmitted by a network node; a transmission unit 1124 for employing a transmitter to transmit a first signal comprising a first message as a result of the UE receiving the first scheduling message; and a buffering unit 1126 for buffering the first message, after transmitting the first signal, in case the network node requires the UE to retransmit the first message. The receiver unit 1122 is further operable to receive a second scheduling message transmitted by the network node, the second scheduling message instructing the UE to transmit a second message, and the transmission unit 1124 is further operable to, as a result of the UE receiving the second scheduling message, employ the transmitter to transmit a second signal comprising the second message but not comprising the first message. The receiver unit 1122 is further operable to receive i) acknowledgment information transmitted by the network node, wherein the acknowledgment information indicates that the network node has been able to obtain the first message from the first signal and the second message from the second signal or ii) a request to retransmit the first message. The buffering unit 1126 is further configured such that, as a result of the UE receiving the acknowledgment information indicating that the network node has been able to obtain the first message from the first signal, the buffering unit 1126 de-buffers the first message.

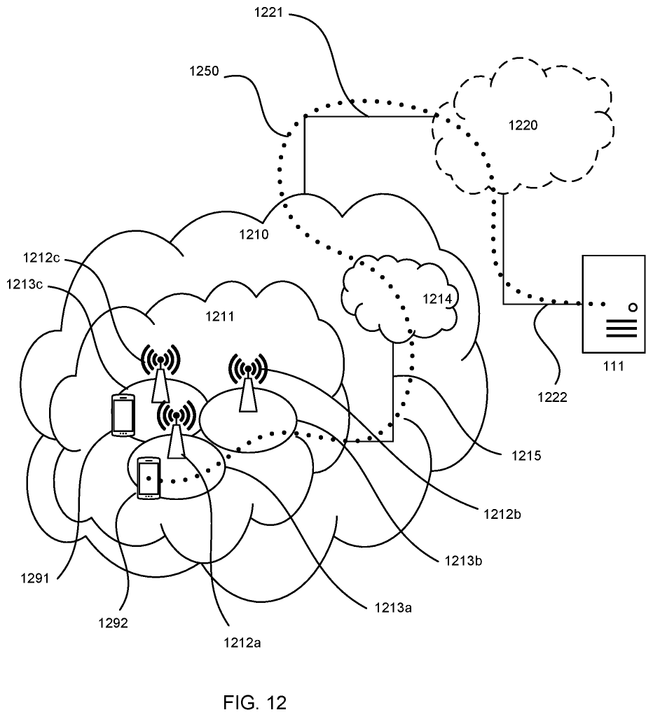

FIG. 12 illustrates a telecommunication network connected via an intermediate network to a host computer 111 in accordance with some embodiments. With reference to FIG. 12, in accordance with an embodiment, a communication system includes telecommunication network 1210, such as a 3GPP-type cellular network, which comprises access network 1211, such as a radio access network, and core network 1214. Access network 1211 comprises a plurality of APs (hereafter base stations) 1212a, 1212b, 1212c, such as NB s, eNBs, gNBs or other types of wireless access points, each defining a corresponding coverage area 1213a, 1213b, 1213c. Each base station 1212a, 1212b, 1212c is connectable to core network 1214 over a wired or wireless connection 1215. A first UE 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Telecommunication network 1210 is itself connected to host computer 111, which may be embodied in the hardware and/or software of a standalone server, a cloud-implemented server, a distributed server or as processing resources in a server farm. Host computer 111 may be under the ownership or control of a service provider, or may be operated by the service provider or on behalf of the service provider. Connections 1221 and 1222 between telecommunication network 1210 and host computer 111 may extend directly from core network 1214 to host computer 111 or may go via an optional intermediate network 1220. Intermediate network 1220 may be one of, or a combination of more than one of, a public, private or hosted network; intermediate network 1220, if any, may be a backbone network or the Internet; in particular, intermediate network 1220 may comprise two or more sub-networks (not shown).

The communication system of FIG. 12 as a whole enables connectivity between the connected UEs 1291, 1292 and host computer 111. The connectivity may be described as an over-the-top (OTT) connection 1250. Host computer 111 and the connected UEs 1291, 1292 are configured to communicate data and/or signaling via OTT connection 1250, using access network 1211, core network 1214, any intermediate network 1220 and possible further infrastructure (not shown) as intermediaries. OTT connection 1250 may be transparent in the sense that the participating communication devices through which OTT connection 1250 passes are unaware of routing of uplink and downlink communications. For example, base station 1212 may not or need not be informed about the past routing of an incoming downlink communication with data originating from host computer 111 to be forwarded (e.g., handed over) to a connected UE 1291. Similarly, base station 1212 need not be aware of the future routing of an outgoing uplink communication originating from the UE 1291 towards the host computer 111.

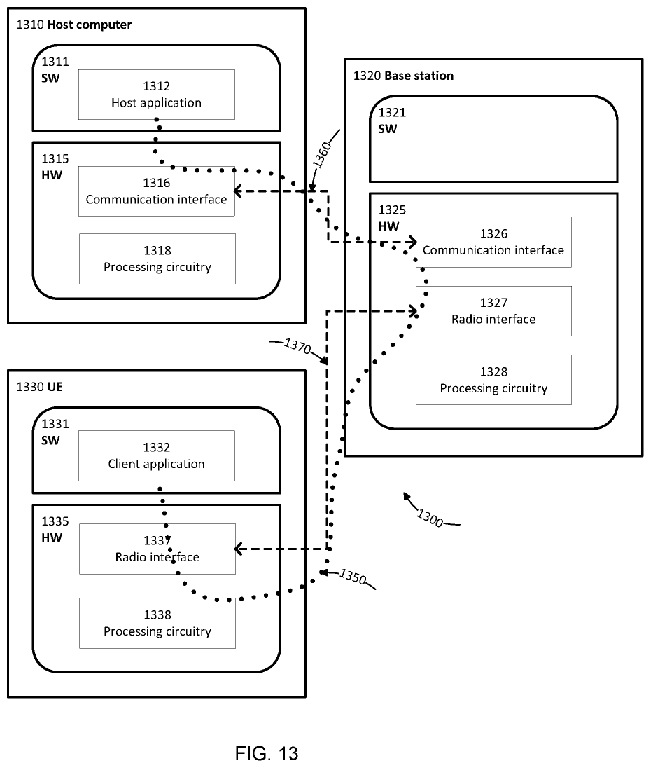

Example implementations, in accordance with an embodiment, of the UE, base station and host computer discussed in the preceding paragraphs will now be described with reference to FIG. 13, which illustrates a host computer communicating via a base station with a user equipment over a partially wireless connection in accordance with some embodiments. In communication system 1300, host computer 1310 comprises hardware 1315 including communication interface 1316 configured to set up and maintain a wired or wireless connection with an interface of a different communication device of communication system 1300. Host computer 1310 further comprises processing circuitry 1318, which may have storage and/or processing capabilities. In particular, processing circuitry 1318 may comprise one or more programmable processors, application-specific integrated circuits, field programmable gate arrays or combinations of these (not shown) adapted to execute instructions. Host computer 1310 further comprises software 1311, which is stored in or accessible by host computer 1310 and executable by processing circuitry 1318. Software 1311 includes host application 1312. Host application 1312 may be operable to provide a service to a remote user, such as UE 1330 connecting via OTT connection 1350 terminating at UE 1330 and host computer 1310. In providing the service to the remote user, host application 1312 may provide user data which is transmitted using OTT connection 1350.

Communication system 1300 further includes base station 1320 provided in a telecommunication system and comprising hardware 1325 enabling it to communicate with host computer 1310 and with UE 1330. Hardware 1325 may include communication interface 1326 for setting up and maintaining a wired or wireless connection with an interface of a different communication device of communication system 1300, as well as radio interface 1327 for setting up and maintaining at least wireless connection 1370 with UE 1330 located in a coverage area (not shown in FIG. 13) served by base station 1320. Communication interface 1326 may be configured to facilitate connection 1360 to host computer 1310. Connection 1360 may be direct or it may pass through a core network (not shown in FIG. 13) of the telecommunication system and/or through one or more intermediate networks outside the telecommunication system. In the embodiment shown, hardware 1325 of base station 1320 further includes processing circuitry 1328, which may comprise one or more programmable processors, application-specific integrated circuits, field programmable gate arrays or combinations of these (not shown) adapted to execute instructions. Base station 1320 further has software 1321 stored internally or accessible via an external connection.

Communication system 1300 further includes UE 1330 already referred to. Its hardware 1335 may include radio interface 1337 configured to set up and maintain wireless connection 1370 with a base station serving a coverage area in which UE 1330 is currently located. Hardware 1335 of UE 1330 further includes processing circuitry 1338, which may comprise one or more programmable processors, application-specific integrated circuits, field programmable gate arrays or combinations of these (not shown) adapted to execute instructions. UE 1330 further comprises software 1331, which is stored in or accessible by UE 1330 and executable by processing circuitry 1338. Software 1331 includes client application 1332. Client application 1332 may be operable to provide a service to a human or non-human user via UE 1330, with the support of host computer 1310. In host computer 1310, an executing host application 1312 may communicate with the executing client application 1332 via OTT connection 1350 terminating at UE 1330 and host computer 1310. In providing the service to the user, client application 1332 may receive request data from host application 1312 and provide user data in response to the request data. OTT connection 1350 may transfer both the request data and the user data. Client application 1332 may interact with the user to generate the user data that it provides.

It is noted that host computer 1310, base station 1320 and UE 1330 illustrated in FIG. 13 may be similar or identical to host computer 111, one of base stations 1212a, 1212b, 1212c and one of UEs 1291, 1292 of FIG. 12, respectively. This is to say, the inner workings of these entities may be as shown in FIG. 13 and independently, the surrounding network topology may be that of FIG. 12.

In FIG. 13, OTT connection 1350 has been drawn abstractly to illustrate the communication between host computer 1310 and UE 1330 via base station 1320, without explicit reference to any intermediary devices and the precise routing of messages via these devices. Network infrastructure may determine the routing, which it may be configured to hide from UE 1330 or from the service provider operating host computer 1310, or both. While OTT connection 1350 is active, the network infrastructure may further take decisions by which it dynamically changes the routing (e.g., on the basis of load balancing consideration or reconfiguration of the network).

Wireless connection 1370 between UE 1330 and base station 1320 is in accordance with the teachings of the embodiments described throughout this disclosure. One or more of the various embodiments improve the performance of OTT services provided to UE 1330 using OTT connection 1350, in which wireless connection 1370 forms the last segment. More precisely, the teachings of these embodiments may improve one or more of message throughput, SINR, latency, overhead, and power consumption and thereby provide benefits such as reduced user waiting time, better responsiveness, extended battery lifetime, etc.

A measurement procedure may be provided for the purpose of monitoring data rate, latency and other factors on which the one or more embodiments improve. There may further be an optional network functionality for reconfiguring OTT connection 1350 between host computer 1310 and UE 1330, in response to variations in the measurement results. The measurement procedure and/or the network functionality for reconfiguring OTT connection 1350 may be implemented in software 1311 and hardware 1315 of host computer 1310 or in software 1331 and hardware 1335 of UE 1330, or both. In embodiments, sensors (not shown) may be deployed in or in association with communication devices through which OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of OTT connection 1350 may include message format, retransmission settings, preferred routing etc.; the reconfiguring need not affect base station 1320, and it may be unknown or imperceptible to base station 1320. Such procedures and functionalities may be known and practiced in the art. In certain embodiments, measurements may involve proprietary UE signaling facilitating host computer 1310's measurements of throughput, propagation times, latency and the like. The measurements may be implemented in that software 1311 and 1331 causes messages to be transmitted, in particular empty or ‘dummy’ messages, using OTT connection 1350 while it monitors propagation times, errors etc.

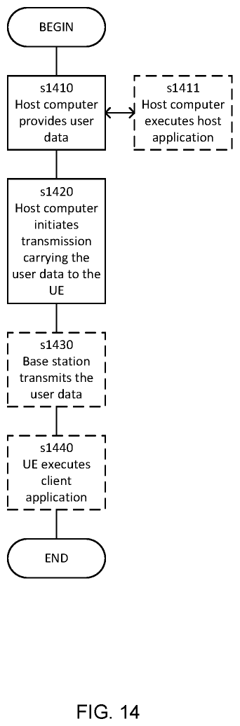

FIG. 14 is a flowchart illustrating a method implemented in a communication system, in accordance with one embodiment. The communication system includes a host computer, a base station and a UE which may be those described with reference to FIG. 12 and FIG. 13. In step S1410, the host computer provides user data. In substep S1411 (which may be optional) of step S1410, the host computer provides the user data by executing a host application. In step S1420, the host computer initiates a transmission carrying the user data to the UE. In step S1430 (which may be optional), the base station transmits to the UE the user data which was carried in the transmission that the host computer initiated, in accordance with the teachings of the embodiments described throughout this disclosure. In step S1440 (which may also be optional), the UE executes a client application associated with the host application executed by the host computer.

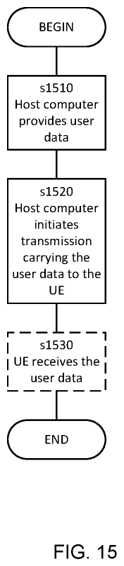

FIG. 15 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 15 will be included in this section. In step S1510 of the method, the host computer provides user data. In an optional substep (not shown) the host computer provides the user data by executing a host application. In step S1520, the host computer initiates a transmission carrying the user data to the UE. The transmission may pass via the base station, in accordance with the teachings of the embodiments described throughout this disclosure. In step S1530 (which may be optional), the UE receives the user data carried in the transmission.

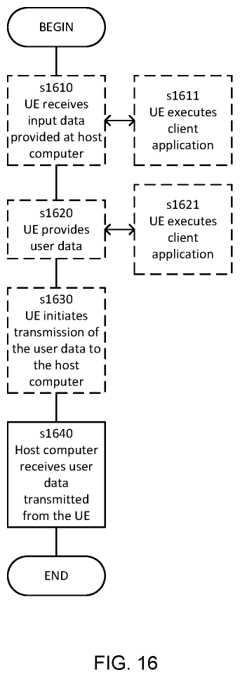

FIG. 16 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 16 will be included in this section. In step S1610 (which may be optional), the UE receives input data provided by the host computer. Additionally or alternatively, in step S1620, the UE provides user data. In substep S1621 (which may be optional) of step S1620, the UE provides the user data by executing a client application. In substep S1611 (which may be optional) of step S1610, the UE executes a client application which provides the user data in reaction to the received input data provided by the host computer. In providing the user data, the executed client application may further consider user input received from the user. Regardless of the specific manner in which the user data was provided, the UE initiates, in substep S1630 (which may be optional), transmission of the user data to the host computer. In step S1640 of the method, the host computer receives the user data transmitted from the UE, in accordance with the teachings of the embodiments described throughout this disclosure.

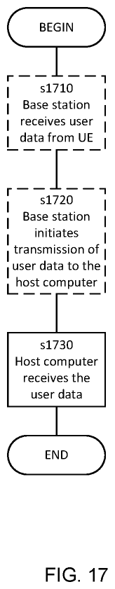

FIG. 17 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 17 will be included in this section. In step S1710 (which may be optional), in accordance with the teachings of the embodiments described throughout this disclosure, the base station receives user data from the UE. In step S1720 (which may be optional), the base station initiates transmission of the received user data to the host computer. In step S1730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-11. canceled

12. A method for obtaining a first message transmitted by a first user equipment (UE) and a second message transmitted by a second UE, the method being performed by a network node and comprising:
scheduling the first UE to transmit the first message using a first time and frequency resource;
scheduling the second UE to transmit the second message using the first time and frequency resource;
receiving a first signal comprising the first message and the second message; and
as a result of not being able to obtain either the first message or the second message from the signal, performing steps comprising:
buffering the first signal;
scheduling the first UE to retransmit the first message using a second time and frequency resource; and
scheduling the second UE to transmit a third message using the second time and frequency resource, wherein the third message is different than the second message.

13. The method of claim 12, further comprising:
receiving a second signal comprising the first message and the third message;
obtaining the first message from the second signal;
obtaining the third message from the second signal; and
using the first message obtained from the second signal and the buffered first signal, obtaining the second message from the first signal.

14. The method of claim 13, wherein obtaining the second message from the first signal comprises:
removing the first message from the first signal, thereby producing a residual signal comprising the second message; and
obtaining the second message from the residual signal.

15. The method of claim 12, further comprising:
receiving a second signal comprising the first message and the third message; and
as a result of not being able to obtain either the first message or the third message from the second signal, performing steps comprising:
buffering the second signal;
scheduling the first UE to retransmit the first message using a third time and frequency resource; and
scheduling the second UE to transmit a fourth message using the second time and frequency resource, wherein the fourth message is different than the second message and third message.

16. The method of claim 12, wherein scheduling the second UE to transmit the third message comprises transmitting to the second UE a scheduling message comprising information for causing the second UE to buffer the second message in case the second UE needs to retransmit the second message.

17. A method performed by a first user equipment (UE) for transmitting messages to a network node, the method comprising:
receiving a first scheduling message transmitted by the network node;
as a result of receiving the first scheduling message, transmitting a first signal comprising a first message;
after transmitting the first signal, buffering the first message in case the network node requires the UE to retransmit the first message;
after buffing the first message, receiving a second scheduling message transmitted by the network node, the second scheduling message instructing the UE to transmit a second message;
as a result of receiving the second scheduling message, transmitting a second signal comprising the second message but not comprising the first message; and
after transmitting the second signal, receiving:
i) acknowledgment information transmitted by the network node, wherein the acknowledgment information indicates that the network node has been able to obtain the first message from the first signal and the second message from the second signal, or
ii) a request to retransmit the first message.

18. A computer program product comprising a non-transitory computer readable medium storing a computer program comprising instructions which, when executed by processing circuitry, causes the processing circuitry to carry out the method of claim 12.

19. canceled

20. canceled

21. A network node, the network node comprising:
a scheduling unit for scheduling a first UE (UE1) to transmit a first message using a first time and frequency resource and scheduling a second UE (UE2) to transmit a second message using the first time and frequency resource;
a receiver unit configured to receive via a receiver a first signal comprising the first message and the second message;
a buffering unit; and
a determining unit, wherein
the determining unit is operable to determine whether the network node, NN, is able to obtain either the first message or the second message from the first signal, and
as a result of the determining unit determining that the NN is not able to obtain either the first message or the second message from the first signal, the buffering unit buffers the first signal and the scheduling unit schedules the first UE to retransmit the first message using a second time and frequency resource and schedules the second UE to transmit a third message using the second time and frequency resource, wherein the third message is different than the second message.

22. canceled

23. A first user equipment, the first user equipment, UE1, comprising:
a receiver unit for receiving a first scheduling message transmitted by a network node;
a transmission unit for employing a transmitter to transmit a first signal comprising a first message as a result of UE1 receiving the first scheduling message; and
a buffering unit for buffering the first message, after transmitting the first signal, in case the network node requires UE1 to retransmit the first message, wherein
the receiver unit is further operable to receive a second scheduling message transmitted by the network node, the second scheduling message instructing the UE to transmit a second message,
the transmission unit is further operable to, as a result of the UE receiving the second scheduling message, employ the transmitter to transmit a second signal comprising the second message but not comprising the first message, and
the receiver unit is further operable to receive i) acknowledgment information transmitted by the network node, wherein the acknowledgment information indicates that the network node has been able to obtain the first message from the first signal and the second message from the second signal or ii) a request to retransmit the first message.

24. The first user equipment of claim 23, wherein the buffering unit is further configured such that, as a result of UE1 receiving the acknowledgment information indicating that the network node has been able to obtain the first message from the first signal, the buffering unit de-buffers the first message.
